(19) United States
(12) Patent Application Publication
(10) Pub. No.: US 2009/0019019 A1
(43) Pub. Date: Jan. 15, 2009

(54) METHOD AND SYSTEM FOR OBTAINING INFORMATION

(75) Inventors: John-Paul Jones, London (GB); David Charles Harrison, Kent (GB)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: THE DIALLOG WORKS LTD., London (GB)

(21) Appl. No.: 11/995,509

(22) PCT Filed: Jun. 26, 2006
(86) PCT No.: PCT/GB2006/002334

§ 371 Date: Sep. 18, 2008

(30) Foreign Application Priority Data
Jul. 12, 2005 (GB) 0514325.0

(51) Int. Cl. G06F 7/06; G06F 17/30; G06F 15/16

(52) U.S. Cl. 707/4; 707/5; 709/202; 707/E17.108

(57) ABSTRACT

A method and system which allows for information pertaining to search requests made from an information source to be tracked with respect to whether the information provided is then used is described. In particular, the invention provides a method and system whereby contact information in particular can be monitored, to determine whether communications in accordance with the contact information are subsequently established after provision of the contact information in response to a search request. This is achieved by receiving information relating to a search request and providing a data item or token having a particular value, identity, or other discernible property and which is indicative of the contents of the search term. The data item or token having the discernible property is provided for communication to a user who has performed a search request, together with contact information provided as a result of the search request. A monitoring process is then undertaken to determine whether the user establishes a communications session with a third party in accordance with the provided contact information, and if such a session is established the discernible property of the data item or token is elicited from the user. By then reviewing the elicited property (for example by comparison against a database or the like, or by applying a known function to the property value) the contents of the search term can be determined. In this way, information as to which search terms ultimately lead to contact being established can be found.

### TECHNICAL FIELD

The present invention relates to a method and system for obtaining information, and in particular to tracking search terms used to search an information repository. It finds particular, although not exclusive, use in the field of Internet advertising and search engine marketing conducted on the World Wide Web (WWW). Particular embodiments provide a new and useful method, system and computer program for providing a means to track and analyse communications to advertisers, merchants or the like which originated from paid Internet advertisements.

### BACKGROUND TO THE INVENTION AND PRIOR ART

Search engines are commonly used to search the information available on computer networks such as the World Wide Web to enable users to locate information of interest that is stored within the network. To use a search engine, a user or searcher typically enters one or more search terms and the search engine uses those to generate a listing of information, such as web pages, that the searcher is then able to access and utilise.

The basic search method is based on single keyword matching. The keyword is searched for and all documents containing this word will be retrieved. It is also possible to search for a keyword prefix and all documents where this prefix is present in any keyword in the documents, will be retrieved. Instead of searching with keywords, the search is sometimes based on exact phrase matching, where the search uses several single keywords in particular sequence.

One type of search engine that provides web page operators and advertisers with a more predictable method of being found as the result of a search is a “Pay Per Click” (PPC) arrangement where web pages are displayed in an order determined by a payment that the advertiser or web page operator has agreed to make to the search engine operator.

A PPC search engine works like an online version of the Yellow Pages®: a user performs a search, and the system displays paid advertiser listings that match the user's query. Each advertiser's listing includes a title, descriptive text and a clickable hyperlink or uniform resource locator (URL). The database of search listings stores many such listings, each associated with an advertiser. Upon receipt of the query, the database is searched and listings having a search term matching the query are formatted for display to the searcher as search results. To provide this functionality, web sites typically sell keywords to advertisers. Since multiple advertisers may desire the same keyword, the web sites often auction desirable keywords to the highest bidders.

The attractiveness of Internet PPC search marketing to advertisers is that they can generate a large quantity of pre-qualified sales leads at a relatively low cost. Also, by utilising the data which is generated and captured each time a searcher ‘clicks’ on their web site, they can easily determine their ‘cost per acquisition’ (CPA) for each lead and, if a sale is made, their ‘return on investment’ (ROI) for each keyword which they have paid for, and for their search marketing campaign as a whole. This data is important as it allows for each search marketing campaign to be monitored for effectiveness and optimised for results.

A new form of Internet paid search advertising has recently been introduced, whereby the adverts that are shown to a searcher contain a telephone number as well as (or instead of) a website address. This is referred to as “Pay Per Call”® (PPCall). The telephone number is usually generated from a list of numbers which are then allocated according to the identity of the advertiser. If a visitor rings the given telephone number, the advertiser then pays the search engine for that call.

PPCall provides the opportunity for web searchers (users) to talk directly with the advertisers (merchants), rather than only have access to the information displayed on a web page. It provides the choice of a telephone payment transaction for those reluctant to use their credit card on the Internet. It provides an effective means of generating pre-qualified customer leads for suppliers of local services such as tradespeople who have no physical product to sell. And, it allows businesses without search optimised websites to utilise paid search on the Internet.

However, for any advertiser it has severe limitations when compared with PPC campaigns in respect of the scope of the CPA and ROI data which can be generated; as only a limited number of statistics are traditionally available, such as the number of calls made, and time of day an individual call was placed. Ideally other information would be desirable, such as information to identify the search engine and the keyword that had been searched as well as the outcome of the call placed by the searcher. Only from this detailed information could adequate CPA and ROI data be made available for analysis.

One solution to the problem of obtaining this information is described in US 2004/0107137A1 (Skinner), which relates to an automated web ranking bid management account system. In particular, within Skinner a tracking engine provides a tracking URL, which has embedded within it a keycode to help identify the search engine which directed a user to an advertiser's website. The keycode also identifies the search term which was used at the search engine. A content management system which hosts the advertiser's website then displays on the website a unique telephone number per website or per web page. Since each telephone number corresponds with a unique keycode, which in turn identifies the search engine and search term used, telephonic sales can be tracked to a particular keycode and hence search engine and search term. Thus, the information required to operate a pay-per-call method is obtained.

However, as noted above, Skinner relies on using a unique telephone number for each keyword/search engine combination. This raises the problem that for large scale advertisers such as financial product or travel suppliers who typically advertise on thousands of keywords simultaneously over a number of search engines, there would not be enough telephone numbers available to relate one number to each combination of search engine and keyword. This is a particular problem in countries with heavily regulated telecoms industries, such as the UK, and which derives from the technical problem of the lack of addressing space within incumbent telephone networks, and the ability to assign network addresses (telephone numbers), resting with the central public-network operators.

There is therefore a clear requirement for a new method to track in detail the process and outcome of PPCall Internet advertising and provide sufficient data from which adequate CPA and ROI statistics (for example) can be extracted and utilised. More generally, in any form of information provision it would be desirable to allow for information concerning the keywords or other search terms which led to the information being provided in response to a search request to be discoverable but without requiring a unique telephone number to be assigned thereto. Such information may then be used in future information indexing and search applications.

### SUMMARY OF THE INVENTION

In view of the above, the present invention provides a method and system which allows for information pertaining to search requests made from an information source to be tracked with respect to whether the information provided is then used. In particular, the invention provides a method and system whereby contact information in particular can be monitored, to determine whether communications in accordance with the contact information are subsequently established after provision of the contact information in response to a search request. This is achieved by receiving information relating to a search request and providing a data item or token having a particular value, identity, or other discernible property and which is indicative of the contents of the search term. The data item or token having the discernible property is provided for communication to a user who has performed a search request, together with contact information provided as a result of the search request. A monitoring process is then undertaken to determine whether the user establishes a communications session with a third party in accordance with the provided contact information, and if such a session is established the discernible property of the data item or token is elicited from the user. By then reviewing the elicited property (for example by comparison against a database or the like, or by applying a known function to the property value) the contents of the search term can be determined. In this way, information as to which search terms ultimately lead to contact being established can be found, by virtue of the use of the tokens. In particular, the use of the tokens means that no separate telephone number or other network address must be assigned to a search engine/keyword tuple, and the token is decoupled from the contact information.

In view of the above, from a first aspect there is provided a method of tracking search information, comprising the steps of:—
receiving data indicative of at least a search term used by a user to perform a search of an information source;
generating a token having a property indicative of the search term;
providing the token for communication to the user;
receiving data indicative that the user has undertaken a communications session with a third party and communicated the token to the third party; and
storing information relating to said communications session in a data store.

From a further aspect there is provided a method for use in tracking search information, comprising:—
receiving information relating to a search which has been performed of an information source, said information including data indicative of a search term used to perform said search;
parsing said received information to determine said data indicative of said search term;
forwarding said determined data to a data source;
receiving a token from said source, said token having a property indicative of the search term;
providing said token for communication to a user that performed the search; and then subsequently:
receiving data indicative that the user has undertaken a communications session with a third party and communicated the token to the third party; and
providing information relating to said communications session for storage.

A third aspect of the invention provides a method for use in tracking search information, comprising the steps of:—
identifying that a search has been performed, and determining information relating to the search, said information including data indicative of a search term used;
forwarding said information to a tracking platform;
receiving a token having a property indicative of the search term from said tracking platform; and
forwarding said token to a user.

Moreover, a further aspect of the invention provides a method for use in tracking search information, comprising the steps of:—
receiving an incoming request from a user for establishment of a communications session with a third party;
receiving information indicative of a property of a token from the user, said property being indicative of a search term used in a search of an information source previously conducted by the user;
providing said information for storage; and
establishing said communications session between said user and said third party.

Furthermore, another aspect of the invention provides a method for use in tracking search information comprising the steps of:
receiving a search request comprising one or more search terms from a user;
performing a search of an information source to determine one or more pertinent search results, each search result being associated with a third party;
sending a query message including data indicative of at least one of the search terms to a data source;
receiving, in response to the query message, at least one token having a property indicative of the at least one search term; and
providing the search results together with the token to the user.

Further aspects and features of the invention will become apparent from the appended claims.

### BRIEF DESCRIPTION OF THE DRAWINGS

Further features and advantages of the present invention will become apparent from the following description of embodiments thereof, presented by way of example only, and by reference to the accompanying drawings, wherein like reference numerals refer to like parts, and wherein:—

FIG. 1 is a block diagram generally representing a computer server which may be used in embodiments of the invention;

FIG. 2 illustrates a hierarchy of data elements available in a web browser in an embodiment of the invention;

FIG. 3 illustrates the data elements that are used in an embodiment of the present invention;

FIG. 4 is a block diagram showing a functional configuration example according to an embodiment of the present invention;

FIG. 5 is a flow chart diagram outlining a function to retrieve information from tracking tags embedded within a query string used in an embodiment of the invention;

FIG. 6 is a flow chart diagram outlining a function to retrieve information from the query string of the referrer URL used in an embodiment of the invention;

FIG. 7 is a block diagram illustrating the system architecture of another embodiment of the invention; and

FIG. 8 is a block diagram illustrating the system architecture of a further embodiment of the invention.

### DESCRIPTION OF THE EMBODIMENTS

Embodiments of the invention will now be described. The embodiments of the invention to be described are based upon the scenario of providing search term tracking for use within paid online advertising systems on the World Wide Web. However, the invention is not limited to such use and other embodiments that make use of the principles of the invention in different applications may be readily envisaged. Such other applications may be based upon the embodiments to be described or upon other alternative but equivalent architectures.

Prior to describing the particular embodiments to be described, to aid the reader in understanding the embodiments we provide below a glossary of terms used in the following description. This glossary is included solely as an aid to understand the description, and should not be used as a lexicon to directly and exclusively interpret the claims. Instead, it should be understood that the following glossary forms part of the description and is intended to be considered in combination with the remainder of the description of the embodiments.

### Algorithm

A computer program, or set of programs, which is designed to systematically solve a certain kind of problem.

### API

Application Programming Interface. A defined set of calling conventions allowing a software application to access a particular set of services.

### Application

A computer program which runs within the Operating System environment.

### Bus

A set of conductors (wires or connectors in a circuit) connecting the various functional units in a computer.

### Calling

Software subroutines, or procedures, can be “called” from another part of the software code, thus allowing programs to access the procedure repeatedly without the subroutine code needing to be written more than once.

### Check Digit

Digit added to the end of a set of digits in a system which allows for detection of errors in the recording or entering of the set of numbers. Through the use of the check digit and a predetermined mathematical formula, recording errors such as digit reversal can be detected, allowing further action to be taken to correct the error.

### CLI

Caller Line Identification. A service on the public telephone network which shows the telephone number of the person making the call before the call has been answered. Split into two parts, the first of which is the geographic telephone code, the second of which is the local telephone number. E.g. (01234) 567890.

### Client Telephone Number

This is the telephone number which is displayed to the visitor using a web client, and would be subsequently dialled by the visitor. Telephone numbers are preallocated to clients from a pool of available telephone numbers, which are bought from a telephone number provider and stored in a data source. When rung, the telephone number is answered by the telephone switch. Numbers are assigned in pairs to a merchant. The first number is classed as the generic client telephone number, which is shown if no specific extension information can be retrieved; the second number is used when there is extension information available. This is to enable the telephone switch to determine whether to route the inbound call direct to the merchant, or pass it through the IVR, by comparing the DDI with the local data source

### Communication Link

A communication link is a connection made over a network between two computers, using equipment such as a network interface or a modem. By example, but not limitation, the network may be the Internet, or the public telephone network.

### Communication Protocol

This is an agreed upon format for transmitting data between two devices (E.g. Transmission Control Protocol/Internet Protocol (TCP/IP). The protocol may determine, for example, the type of error checking and data compression method used.

### Cookie

A cookie typically comprises of a small text file written by a web site to a web client requesting content from that web site. Cookies may also be saved to a web client via script interaction within the Document Object Model (DOM). Once saved within a web client, the cookies may be retrieved by the web site, or retrieved via script interaction within the Document Object Model (DOM).

### CSV

Comma Separated Values. A file format used as a portable representation of a database. Each line is one entry or record; the fields in the record are separated by commas.

### Data Interchange Method (DIM)

A standard of file format allowing the transferring of information between two computer systems. E.g. XML or CSV.

### Data Record

An individual piece of data held in a data source.

### Data Source

Any source of data, such as a database or file.

### DDI

Direct Dialing In. A method of allocating telephone numbers to an ISDN circuit so a number is not tied to an individual telephone line. This is the telephone number dialled by a visitor.

### DTMF Signalling

Dual Tone Multi-Frequency. Used by push-button telephones for dialing, and in network signalling. Pressing a key on the telephone's keypad generates a tone. This is decoded by the telephone switch or telephone exchange to determine which key was pressed.

### Document Object Model (DOM)

A W3C standard, the Document Object Model is a platform- and language-neutral interface that will allow programs and scripts to dynamically access and update the content, structure and style of documents. The document can be further processed and the results of that processing can be incorporated back into the presented page.

### Domain Name

A unique name that identifies a web site. Domain names always have two or more parts, separated by dots. The left part identifies the site, the right part is the grouping under which the name is registered, E.g. mysite.co.uk. mysite identifies the site, .co.uk identifies it as commercial UK.

### Extension Number

A number generated in response to a source domain and keyword, which is displayed on the merchant web site and entered by the visitor into the telephone switch.
   Ethernet card
Hardware in a computer which connects a computer to a network.

### Firewall

Computer hardware and/or software designed to secure a computer or network from unauthorised access.

### Header

The header forms part of the web client request, and contains information such as the type of web client (E.g. Mozilla Firefox™), the web page being requested, cookies, and the referrer.

### HTML

Hyper Text Markup Language. The language that specifies how text will be formatted and displayed in a web browser.

### HTTP

Hyper Text Transfer Protocol. An Internet protocol that performs the request and retrieve functions of a web server. Used between a web client and a web server. Commonly seen as the first part of a URL.

### HTTPS

Secure Hypertext Transfer Protocol (or HTTP over SSL). A protocol enabling the secured transmission of Web pages between a web server and a web client.

### HTTP GET Request

A method of transferring data between a web client and a web server using HTTP. GET encodes data into the query string of a URL, and is visible to the person operating the web browser.

### HTTP POST Request

A method of transferring data between a web client and a web server using HTTP. POST encodes data into the message body, so it is not seen as part of the URL.

### HTTP Session

A sequence of Internet activity made by one web client at one site. If a web client makes no request from a site during a defined period of time (usually 30 minutes), the next request to the web site by the web client would then constitute the beginning of a new visit.

### HTTP Session Data

Temporary data held by the web server in a data source which is linked to an individual HTTP session created when a web client accesses a web site. The data source may contain any number of temporary data variables. Once the session expires, the session data is lost.
   httpd
HTTP daemon. A program that serves information using the HTTP protocol. The Apache™ Web Server is often called an httpd.

### IP Address

A string of four numbers separated by periods (such as 111.22.3.444) used to represent a computer on the Internet, or another network running the IP protocol. The format of the address is specified by the Internet Protocol in RFC 791. If a computer does not have an IP address, it cannot be on a network.

### Internet

A large global electronic communications network comprised of thousands of smaller computer networks, which uses Internet Protocol (IP) to link the various physical networks in a single logical network.

### ISDN

Integrated Services Digital Network. A set of protocols and interface standards that effectively constitutes an integrated telephone network. ISDN can transmit digital data and voice, ideal for videoconferencing.

### IVR

Interactive Voice Response. A system that provides information as recorded messages over telephone lines in response to user input in the form of spoken words, or more commonly, DTMF signalling.

### JavaScript

A scripting language that forms part of the HTML page, and can be used for example to run processes locally or validate data. JavaScript programs are run in the web client on the client side, rather than on a web server.

### LAN

Local Area Network. A computer network that spans a relatively small area. Most LANs are confined to a single building or group of buildings.

### Merchant

An individual person or group of people who operate a business offering services or goods.

### Merchant Telephone Number

The merchant telephone number is a geographical telephone number which is connected to the merchant's telephone system in the merchants place of business.

### Merchant Web Site

The web site of the merchant which displays details of the merchant's products and services.

### Modem

MOdulator DEModulator. A device used to convert serial digital data from a transmitting terminal to a signal suitable for transmission over a telephone channel, or to re-convert the transmitted signal to serial digital data for acceptance by a receiving terminal.

### Network

A network is a group of two or more systems linked together. An example of a network, but not limited to, is the Internet, or the public telephone network.

### Network Interface

Hardware in a computer which enables the transmission of information over a telephone line, wire or cable. Examples include a modem or an Ethernet card.

### Operating System

The collection of software programs used by a computer to manage its own resources, (such as the screen, keyboard, hard disk, network card) and to communicate with the user. Examples of operating systems are Windows XP™ and Linux™. The operating system is the core of the computers operation, and application programs such as a web server or web client run on top of it.

### PPCall

An advertising payment model in which payment is based solely on qualifying telephone calls to a published telephone number. PPCall advertisements are usually text advertisements placed near or within search results, displaying information about a company, and an associated telephone number which a visitor can dial to interact with the company representatives, to make a purchase or to request further information.

### PPC

An online advertising payment model in which payment is based solely on qualifying click-thrus from a publisher web site to the advertisers web site. Pay per click advertisements are usually text advertisements placed near search results.

### Programming Language

A precise, artificial language that enables people to instruct machines. Computer commands that form procedures by which software programmers design and implement computer software programs. An example of a programming language is PHP.

### Procedure

A sequence of code which performs a specific task, as part of a larger program, and is grouped as one, or more, statement blocks. Procedures can be “called”, thus allowing programs to access the subroutine repeatedly without the subroutine's having been written more than once.

### Query String

Included as part of a URL, and is the last part of the URL after the page name. A character string beginning with a question mark (?), composed on name-value pairs of input, separated by ampersands (&). E.g. ?name=Patrick&value=3. Each name-value pair is known as a parameter.

### Record Identifier

A unique identifier, such as an ID number, which uniquely identifies a particular set of data within a data source.

### Referrer

The URL of the web page a web client came from, before entering another site. Each time a visitor clicks a new HTML link on a web page, most web clients report a referrer string to the new site.

### Relational Database

A database system in which the database is organised and accessed according to the relationships between data items without the need for any consideration of physical orientation and relationship.

### Request Packet

A group of data formatted to DIM specifications, sent to a procedure or system from a calling procedure or system in order to pass data to the system for acting upon. E.g. a list of coded instructions such as “operation=add&name=Patrick+test&date=2005-05-05”. By example, but not limitation, the request packet will be transmitted via a HTTP POST Request.

### Requested URL

The URL of the web page that a web client has requested to retrieve from a web server. For example, http://www.example.com/page.htm?&bbcam=googl&bbkid=this+example+keyword

### Response Packet

A group of data formatted to DIM specifications, sent from a procedure or system to the procedure or system which called it. E.g. a string of text containing a telephone number and an extension number formatted as “(01234) 567890”, “33*34241*”

### Return On Investment

ROI is a metric that attempts to determine what the advertiser receives in return for the cost of the advertising, usually in terms of new sales.

### RF

Radio Frequency. Part of electromagnetic waves that is suitable for transferring electronic signals.

### RFC 791

A Request for Comments document which is one of the series of numbered Internet informational documents and standards widely followed by software engineers in the Internet communities. RFC 791 defines the scope, interfaces and operation of the Internet Protocol.

### Scripting Engine

Software which is integrated into a web client. The scripting engine executes statements in a defined programming language, such as JavaScript, and executes the statements within the web client environment.

### Search Engine

A (usually web-based) service for searching the information available on the Internet, made accessible through a web page to anyone with a web client. By example, but not limited to, a search engine could be Google™.

### SQL

Structured Query Language. An industry standard language for creating, updating, and querying a relational database.

### SQL Query

A statement made up of valid SQL language components which is used to perform actions on a relational database.

### SSL

Secure Sockets Layer. A protocol developed for transmitting private documents over the Internet. SSL uses a public-and-private key encryption system, which also includes the use of a digital certificate.

### String

A group of characters. E.g. “hello”

### Success Code

A response given by a procedure to indicate the procedure operated successfully.

### Third Party System

A set of services which are operated by another party, which for the purposes of the current invention, provide a service on the Internet which a visitor to the Third Party System may use, such as a PPCall service. Comprises of at least a web server and a telephone switch.

### Tracking Service Provider

A company or service which monitors click thrus and other metrics to a web site. This is performed by having a tracking tag implemented on the web site, and a procedure to send information from the web site to the tracking service, who would log the information into a data source.

### Tag

A type of instruction bounded by the marks “<” and “>”. Tags are used to mark the semantic or logical structure of a document. A sample is the tag <title> to mark the beginning of a title.

### Tracking Tag

A query string added to a request so that the origin of a particular visit of a web client to a web site can be tracked by a tracking service provider. E.g. one might configure a Pay Per Click advert to direct visitors to www.example.com/?src=google&kw=mytest, so that the tracking service provider knows that the web client came from a Google pay per click advert using the keyword “mytest”.

### Telephone Hardware

Hardware within a computer which enables the computer to be connected to the public telephone network, and which allows the computer to answer, place, and record telephone calls and interact with people at the other end of the telephone connection.

### Temporary Memory

An area of the computers memory which is used by a script to hold a given value. E.g. $thename=“patrick” means that an area of the computer memory is reserved under the name “thename”, and contains the value “Patrick”.

### Timestamp

A value of time held within a computer.

### URL

Uniform Resource Locator; a string of characters which is an address that specifies the location of a file on the Internet. E.g. http://www.example.com/thiswebpage.htm?id=2. The part before the colon specifies the protocol (HTTP). The part after the // is the server hostname (www.example.com). The part after the next/and before the ? is the name of the file on the web server. The part after the ? is the query string, which denotes extra information to pass to the web server.

### Visitor

A visitor is a person who uses a web client to visit a web site on the Internet.

### Voice Over IP

Technology used to transmit voice conversations over a data network using the Internet Protocol described above. The data network involved might be the Internet itself, or a corporate intranet, or managed networks used by local or long distance carriers and ISPs. Voice (i.e., analog information) is encoded digitally and converted into packets. The packets are moved over a data network along the most efficient path to their destination, where they get reassembled and delivered in the format they started in, i.e. audible voice.

### WAN

Wide Area Network. A computer network covering a wide geographical area, involving vast arrays of computers. An example of a WAN is the Internet.

### Web Client

A web client is an application which runs on a computer within the Operating System environment. The purpose of this application is to provide an interface which a person can use to browse web sites made available on accessible networks, by example, but not limited to the Internet. An example of, but not limited to, a web client is Mozilla Firefox.

### Web Page

A document written in HTML that can be accessed on the Internet. Every web page has a unique address called a URL. Web pages can contain text, graphics and hyperlinks to other web pages and files.

### Web Script

A single file, or group of multiple files, which are executed by a web server in response to a request from a web client. The script contains a list of commands in a defined programming language which define how a web page is to be built.

### Web Server

A web server is an application which serves the individual files that make up web pages, which are sent to a web client over a network, using either HTTP or HTTPS protocols. Every computer on the Internet that contains a web site must have a web server application. An example of, but not limited to, a web server application, is Apache httpd.

### Web Site

A collection of electronic pages, generally formatted in HTML, which reside on a web server. Each web site contains a home page, which is the first document visitors see when they enter the site.

### Web Site Client ID

A unique number, or string of characters, which uniquely identifies a particular website or client within the system.

### XML

Extensible Markup Language, a specification developed by the W3C. XML is designed especially for Web documents. It allows designers to create their own customized tags, enabling the definition, transmission, validation, and interpretation of data between applications and between organizations.

Before providing a detailed description of the embodiments, a brief overview of the operation of the embodiments of the invention to be described will be undertaken.

More particularly, embodiments of the invention to be described provide methods, systems and computer programs for providing a means to track and analyse communications sessions such as telephone calls to parties such as advertisers which originated from paid Internet advertisements or other searches, by means of the dynamic real-time generation of data codes indicative of search terms. In the embodiments the data codes are particularly in the form of telephone numbers and telephone extension numbers.

In general, within the embodiments to be described the overall process of tracking online marketing activity through to a telephone call, using a telephone number and extension in response to a web visitor is as follows:

1) A web client visits a web site which supports the current invention. The web server generates the requested page. Data is gathered from the header information of the web client, including the keywords used in the client search process, and this information is passed to the tracking platform.

2) The tracking platform receives the keyword information and checks whether a client session is currently in progress, and whether telephone number information must be provided. If telephone number information is required, the tracking platform queries a data source such as a database or the like with information relating to the web site accessed and the search keywords used to produce the web site visit. The data source takes at least the key words and produces a data code indicative of at least the keywords used in the search term. The data code is produced such that when presented with the data code the search keywords can be derived there from by the data source. In the preferred examples, this is achieved by storing the keywords and the data codes indexed to each other in a look-up table structure or the like, although other two-way functions to produce the data code from the keywords and vice versa may be used. Once the data code, in the preferred form of a number or the like, has been produced it is passed back to the web server.

3) The web server then writes this information into the web page and sends this back to web client to fulfil the original request. Where a telephone number is provided, the data code is preferably presented to the web client as if it is an extension number.

4) The visitor who is operating the web client then telephones the telephone number given in the web page, and is prompted by voice from the telephone switch to enter the data code, which is preferably in the form of the extension number. The visitor enters the extension number.

5) The telephone switch then communicates information about the call and extension number to the tracking platform, which stores the information in the data source, and returns the merchant telephone number to the telephone switch. The merchant telephone number is the actual destination telephone number of the merchant who would answer the call when this number is dialled.

6) The telephone switch dials the merchant, who answers the telephone, and the visitor and merchant are connected and have a discourse.

7) The conversation terminates when either party hangs up the telephone, and the telephone switch then communicates call length for this call back to the tracking platform, which logs the data in data source.

The above demonstrates the basic processing steps used to create the tracking methodology, track the resulting communication session (the telephone call in the preferred embodiment), and log required data relating to which search terms led to the communications session.

The result of these steps is to produce a database of call information which can be mined using standard software query tools, to produce reports and statistics of the off-line performance of online PPC and PPCall marketing activity.

These reports can then be analysed by the merchant to work out where they should spend their Internet advertising money most effectively. The data can also be used to feed into recognised bid management software systems, for example, those marketed before the priority date under the trade names Atlas one point™ or BidBuddy®, which can automatically manage advertising spend based on the ROI data provided to them.

The preferred embodiments of the invention will now be described. As noted previously, the preferred embodiments relate to the provision of a tracking system for use in a call tracking application for on-line searching. As such, the preferred embodiments are primarily implemented as software programs running on a computer operating environment or respective computer operating environments such as conventional computer systems. For completeness, therefore, there follows a description of an exemplary computer operating environment which can be used as the basis of the described embodiments of the invention.

### Exemplary Operating Environment

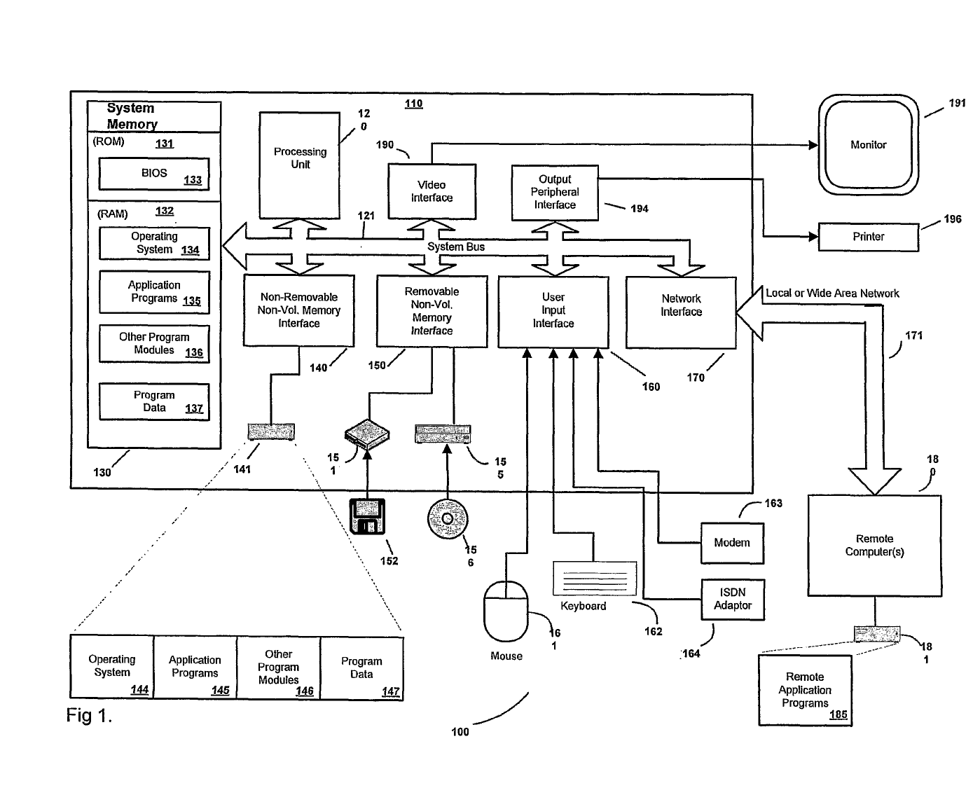

FIG. 1 illustrates an example of a suitable computer system environment 100 on which part of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The embodiments of the invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and non-volatile media, and removable and non-removable media. By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless such as acoustic, RF, infrared and other wireless media. Combinations of any of the above should also be included within the scope of computer-readable media.

The system memory 130 includes computer storage media in the form of volatile and/or non-volatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150. Floppy disk 152 is an example of a storage media which is read by the magnetic disk drive 151. Optical media DVD 156 is read by optical disk drive 155.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a keyboard 162 and pointing device 161, commonly referred to as mouse, trackball or touch pad. Devices such as Modem 163 and ISDN Adaptor 164 can be used to connect the computer to the public telephone network, in order to accept incoming calls, or dial out to 3^{rd} party people or computers. Other input devices not shown in FIG. 1 may include a tablet, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as a printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The connections shown in FIG. 1 depict either a local area network (LAN) or a wide area network (WAN) 171, but may also include other networks. Such networking environments are commonplace in offices, enterprise-wide computer networks, intranets and the Internet. For example, in the present invention, the computer system 110 may comprise a source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN or WAN networking environment, the computer 110 is connected to the LAN or WAN 171 through a network interface or adapter 170.

In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

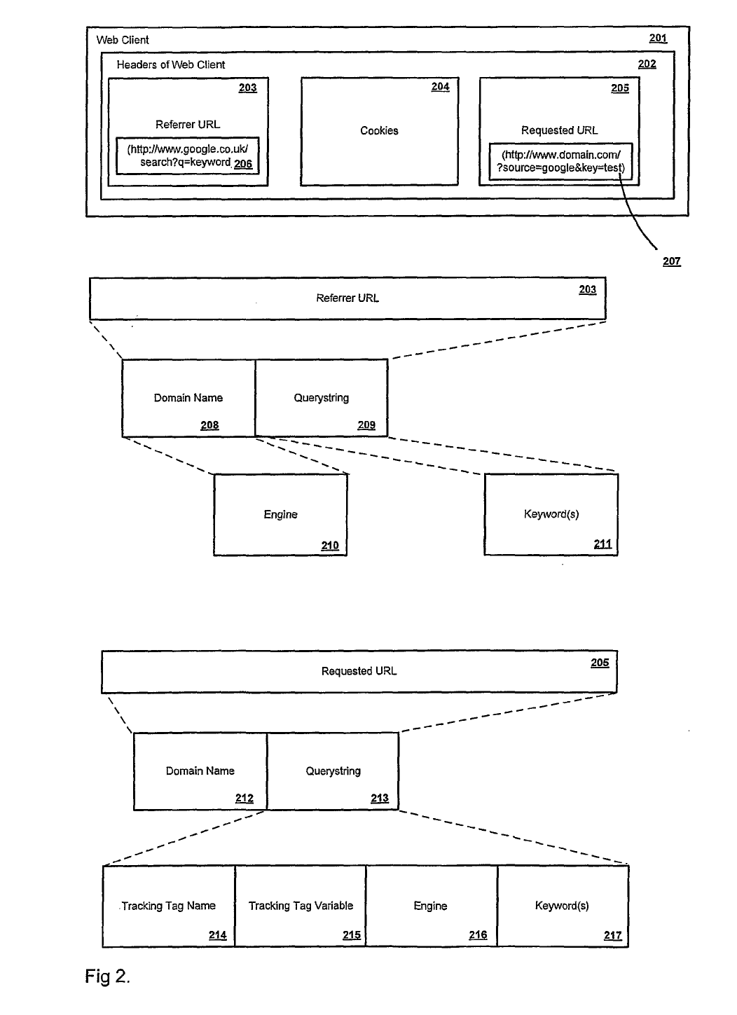

Having described an exemplary operating environment for embodiments of the invention, data such as communication packet structures required for communications between processes used in embodiments of the invention will now be described. In particular, FIG. 2 illustrates the hierarchy of data available within the web client as used in the presently described embodiments.

With reference to FIG. 2, Web Client 201, a standard web browser, by example, but not limited to, Mozilla Firefox, passes information (collectively known as headers 202), with every request to a web server. These headers include the Referrer URL 203, Cookies 204, and the Requested URL 205. The Referrer URL 203 consists of a standard URL 206, as shown in FIG. 2 by example, and relate to the page which directed web client 201 to the current page. The requested URL 205 consists of a standard URL 207, as shown in FIG. 2 by example, and contains the page the web client 201 is requesting from the web server.

Referrer URL 203 consists of two parts, the referrer domain name 208, and the referrer query string 209. The engine information 210 is derived from the referrer domain name 208. The referrer query string 209 contains at least one parameter, which would indicate the keyword information 211. In the present invention, the engine information 210 and keyword information 211 are relevant. An example of the engine information 210 would be “Google”, as taken from the domain name “www.google.com”. An example of keyword information 211 would be “this is a keyword”, as taken from “?q=this+is+a+keyword”.

Requested URL 205 (e.g. “http://www.example.com/page.htm?&bbcam=googl&bbkid=this+example+keyword”) consists of two parts, the domain name being requested 212 (e.g. “www.example.com”), and query string 213 (e.g. “?id=23&bbcam=googl&bbkid=this+example+keyword”) of the request. Query string 213 is furthermore broken down into tracking tags, consisting of tracking tag parameter name 214 (e.g. “bbcam”), and the associated data 215 (e.g. “googl”). From the tracking tags, engine information 216 (“googl”) and keyword 217 (“this example keyword”) can be extracted.

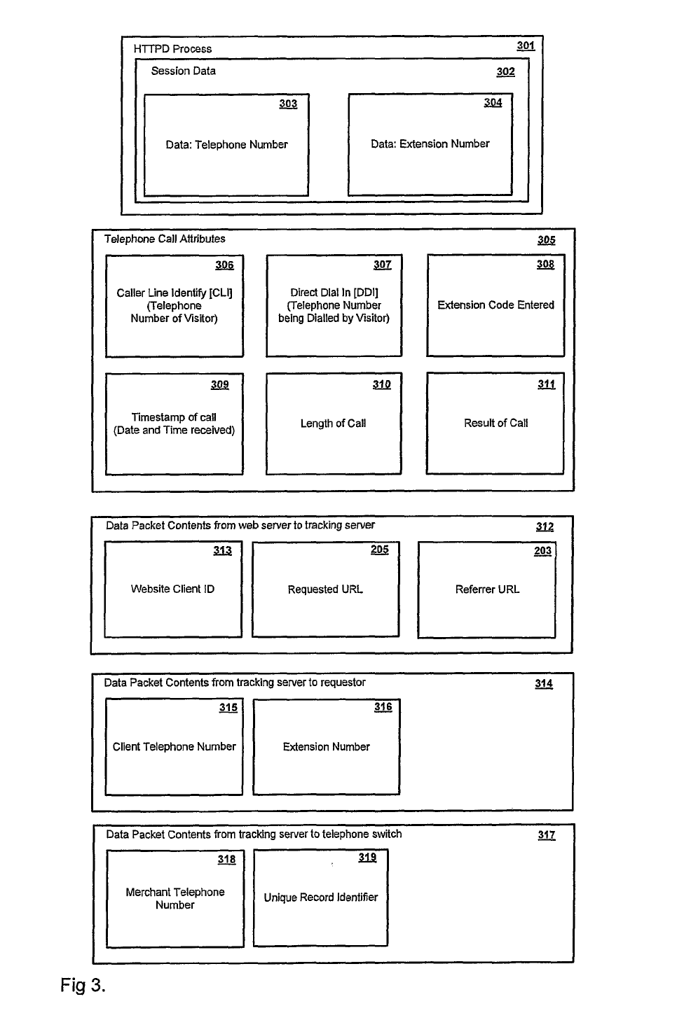

With reference to FIG. 3, a number of further data elements important to the operation of the described embodiments is discussed next.

More particularly, Web Server httpd process 301 is a process which serves web pages in response to requests from a web client 201. The Session Data 302 and the information contained within it is information which is uniquely relevant to web client 201. The elements of data stored within the session data 302 which are relevant to the present information are the client telephone number 303 and the extension number 304. Other information of a programmers choosing may be stored by the httpd process in the session data object 302, but is not directly related to the present invention.

Telephone Call Attributes 305 shows the elements of data which are available on a given telephone call. CLI 306 is the telephone number of the person making a telephone call. DDI 307 is the telephone number which was dialled, which in the present invention is the client telephone number. Extension code 308 is what is entered into the IVR system. Timestamp 309 denotes the date and time the call was made. Length of call 310 is the length of time from the call being placed to the call being terminated. Result of call 311 is data used to specify if a call resulted in a sale, or some other metric of success.

Data Packet 312 contains data items which are sent to the tracking server. It consists of a Website Client ID 313, which is specified in the programming code when setting up the client to use the tracking system, Requested URL 205, and referrer URL 203.

Data Packet 314 contains the client telephone number 315, and the extension number 316, which are displayed on a web site.

Data Packet 317 is sent from the tracking server to the telephone switch, and contains the telephone number of the merchant 318, and a unique identifier 319 which corresponds to the unique entry in the database for a particular telephone call.

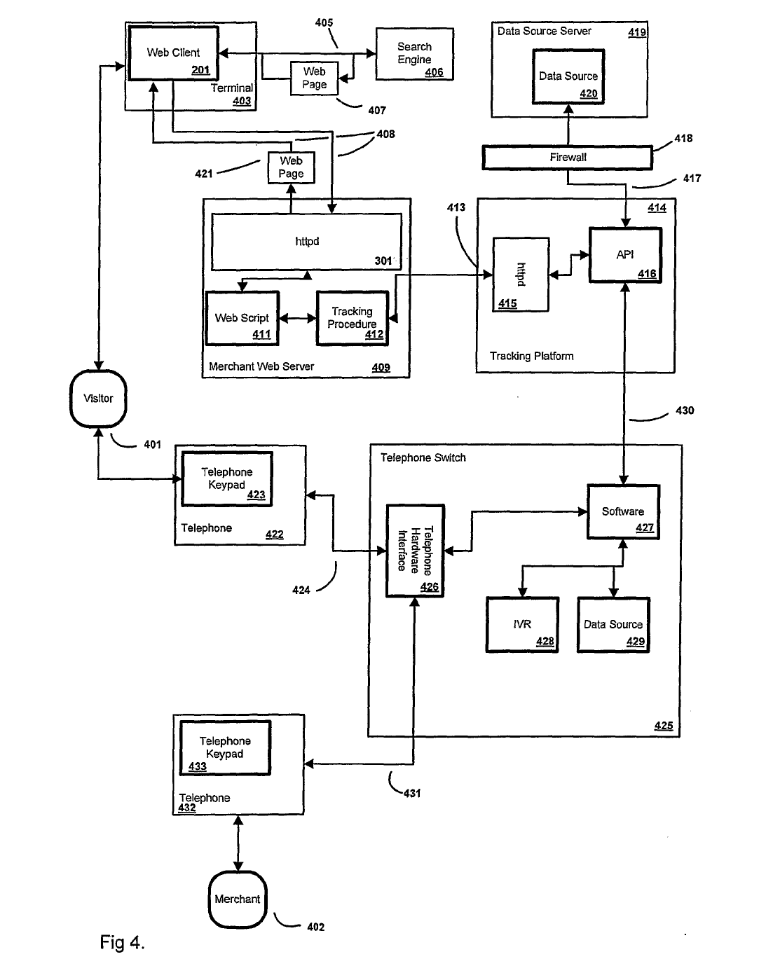

Having described the data packet structure of communications packets used in the preferred embodiments (as shown in FIGS. 2 and 3), and described some of the processes required by those embodiments (with reference to FIG. 3), a detailed description of a first, preferred, embodiment will now be undertaken with reference to FIG. 4.

FIG. 4 illustrates a system architecture block diagram of the preferred first embodiment of the invention, and how the visitor 401 and merchant 402 interact with the various processes and benefit from a result of from the processes which are described below.

For purposes of example, but by no way limited to, computers 403, 409 and 414 are all taken to be reasonably similar to or the same as the exemplary computer environment 101, described previously.

Web Client 201 is an application which runs in computer environment 403, and is controlled by visitor 401.

The visitor 401, as part of their browsing process, performs a search using web client 201 at the web site of search engine 406. Web Client 201 creates a communication link 405 over a network, such as the Internet, and receives web page 407 in response to the query. Web Page 407 contains a list of search results and advertisements related to the query made by visitor 401.

Visitor 401 clicks on a specific search result of interest to them, and in response web client 201 contacts the search engine 406 over communication link 405 to request the URL 205 of the merchant web site.

The search engine web server 406 responds to web client 201 with a Response Packet, which contains the requested URL 205 of the merchant web site. Web client 201 then creates a connection 408 over a network, such as the Internet, to httpd web server process 301, running on computer 409.

The httpd process 301 executes the web script 411 which handles the building of the requested page. As part of the execution of Web Script 411, the script will call tracking procedure 412, to check for the existence of a client telephone number 303 in the session data 302, which can be displayed on the generated web page. This is to determine if tracking procedure 412 needs to request telephone and extension number information to display to the visitor, or if the existing information stored in session 302 is suitable for display.

Typically, cookies 204 are sent with the request for a web page from the web client 201 to the web server httpd process 301 as part of the headers of web client 201. A cookie 204 for the given web site identifies the session ID for that particular web client. The session ID relates to a particular session 302, and each session ID is unique to a web client.

Tracking procedure 412 will perform a number of checks to determine if data should be requested from the tracking platform 414.

If web client 201 does not support cookies, then tracking procedure 412 must request telephone details from the tracking platform 414.

If web client 201 does support cookies, but is a new visitor to the web site, and therefore does not have any session 302 data available, then tracking procedure 412 must request telephone and extension details from the tracking platform 414.

If web client 201 does support cookies, and session 302 exists, but no telephone number 303 or extension number 304 are stored, then tracking procedure 412 must request telephone and extension details from the tracking platform 414.

If web client 201 does support cookies, and session 302 exists, then the procedure will compare the domain name of the Referrer URL 203 with the Requested URL 205 of the merchant web site. If the domain name in the Referrer URL does not match the Requested URL, (i.e. the last page visited by the web client was from a different web site to the merchant web site), then tracking procedure 412 must request details from the tracking platform 414.

From the above conditions, if a need to request a telephone number and extension number has been determined, then the following happens:

Tracking Procedure 412 will extract referrer information 203 from the headers 202 sent by web client 201, which contains the Referrer URL 206 of the previous page visited by the web client 201. Tracking Procedure 412 then builds up a request packet 312.

Procedure 412 then issues a request to the tracking platform 414 by creating a connection 413 over a network, such as the Internet, to the tracking platform API 416, hosted via httpd web server process 415 on tracking platform 414, via the HTTP or preferably HTTPS protocol.

The API Procedure 416 on tracking platform 414 receives the data and extracts website client id 313, requested URL 205, and the referrer URL 203 from the inbound request packet 312.

API procedure 416 extracts the web site domain name 212 (E.g. www.example.com) and the query string 213 (E.g. ?id=23&bbcam-googl&bbkid=this+example+keyword) from the requested URL 205, using standard software functions available in any programming language.

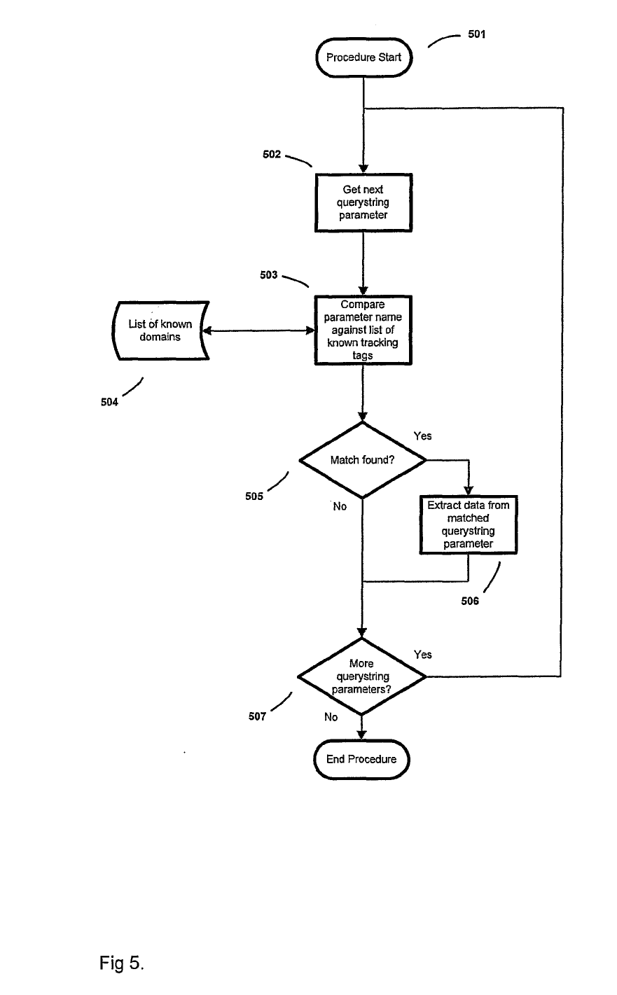

The API Procedure 416 then processes query string 213 of the requested URL 205 for tracking tags, using procedure 501 as described with respect to FIG. 5 below. If any information is returned from procedure 501, then this is stored in temporary memory for later processing.

FIG. 5 describes the procedure 501 which extracts keyword 217 and engine 216 information from tracking tags embedded within a query string 213. Procedure 501 operates as follows.

With reference to FIG. 5, the procedure loops through each parameter contained in the query string 213, and so begins by fetching 502 the first parameter in the query string. Each parameter name is compared in step 503 against a list 504 of known tracking tags names. If a match 505 is found, then the data is extracted at step 506 from the parameter and temporarily stored. The procedure then checks 507 to see if there are more parameters to check in the query string 213. If so, it repeats the loop, returning to step 502, otherwise procedure 501 terminates. If recognised tags are found, the procedure will generally end having found domain 216 and keyword 217 information. These are returned to API procedure 416 when procedure 501 ends.

Returning now to FIG. 4, if no information was returned from procedure 501, then this means that the query string does not contain any tracking tags, and so the domain and keyword information should be extracted in an alternative way. First, API procedure 416 extracts the web site domain name 208 (E.g. www.google.com) and the query string 209 (E.g. ?hl=en&q=example) from the referrer URL 203, using standard software functions available in any programming language.

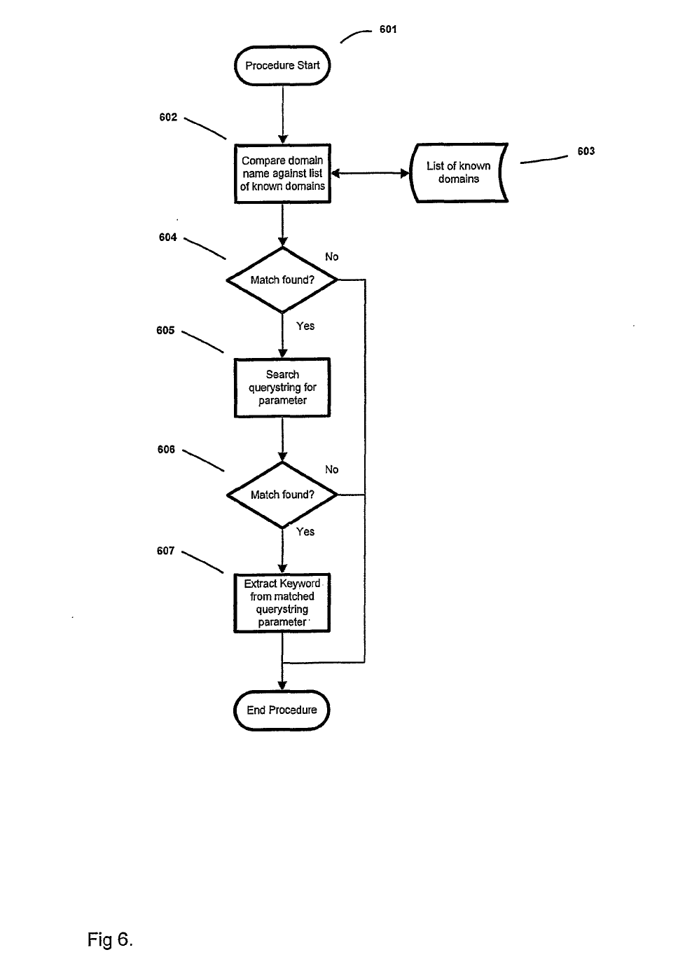

API procedure 416 then attempts to extract the actual keywords 211 used in the referring query from query string 209. This is performed using procedure 601, as described with reference to FIG. 6 below. Keyword information is returned back from procedure 601 to API Procedure 416, and stored in temporary memory.

FIG. 6 describes the procedure 601 which extracts the keyword 211 from a query string 209 using a list of known domains to determine which parameter describes the keywords used.

This procedure begins with step 602 which compares the web site domain name 208 with a list 603. List 603 contains known domain names and the query string parameter associated with the domain, which indicates the keyword. E.g. keyword= is the parameter which contains the keyword for the domain search yahoo.com.

If a match 604 on the domain name is found, then the procedure searches 605 the query string 209 for the existence of the parameter specified from the list. If a match 606 is found, then the procedure at step 607 extracts the keyword from the query string 209 parameter. The keyword information is then returned and procedure 601 terminates.

If no details are found from the previous two processing steps i.e. the keywords cannot be determined, then the procedure needs to retrieve the generic client telephone number 315 for the merchant from data source 420. This is to ensure that a telephone number is always displayed, so that a merchant is always contactable through telephone calls from visitors to the web site hosted on web server 409.

In the preferred first embodiment, the data source 420 is hosted on a separate computer 419 to the tracking platform 414, for reasons of security and speed of response, and is protected from the public internet via a firewall 418. Communication between the tracking platform 414 and data source server 419 is made via a network link 417, which in the preferred embodiment is a LAN. This is by example, and not by limitation. In other embodiments the data source 420 can be hosted within the same computer as the API Procedure 416. In the preferred embodiment, the data source is an SQL database. However, any mechanism of storing and retrieving data is taken to be a valid data source, and other embodiments may use other forms of data storage and retrieval.

To retrieve the merchant telephone number details, API procedure 416 performs a query on data source 420 over communication link 417, using a constructed SQL query which searches for the generic telephone number 315 using the client website id 313 to locate the correct data record. The telephone number is returned from data source 420 to API Procedure 416. It should be noted, however, that the returned telephone number is not the actual telephone number which can be used to contact the merchant directly, but is instead a telephone number allocated to the merchant within the data source, but which connects to a telephone switch which forms part of the first embodiment. This aspect is described in more detail later.

If keyword and search engine details are available from the passed details, then the API procedure 416 on tracking platform 414 performs a query on data source 420 over communication link 417. It uses a constructed SQL query which searches for a specific client telephone number 315 and data code in the form of an extension number 316 for the merchant, using client website id 313, engine and keyword details as extracted from the URLs 203 and 205 in data packet 312 as parameters for the search. Data source 420 returns the client telephone and extension numbers to API Procedure 416 over communication link 417.

In this respect, the data source 420 is organised in such a way that it responds with a unique extension number for each combination of engine and keyword. For example, the data 420 may maintain a look up table of data codes (referred to as extension numbers in the preferred embodiment) indexed against engine name and keywords, with a different data code for each different combination of engine name and keyword. Alternatively, the data source may apply some other form of two way function which allows a unique data code to obtained from the engine and keyword data, and which subsequently allows the engine and keyword data to be derived from the unique data code. Examples of suitable two-way functions would be known lossless coding techniques, or the like. With such techniques, the engine and keyword data is coded (e.g. run-length coded) using a lossless coding algorithm, and the resulting coded data output as the desired data code. For ease of output, the coded data can be output in alphanumeric form, by applying the coded data to a standard character set such as ASCII.

The data code or extension number returned from data source 420 will consist of two parts; a referrer set of digits and a keyword set of digits. In the preferred embodiment where the data code is presented in the form of an extension number, the two sets of digits will be positively separated by a specified digit or valid symbol on a telephone keypad, for example, but not limited to, a (*). This is because the length of the set of digits could be anything from 1 digit up to 5 digits, and a positive separation is required to inform the system where the referrer set of digits end and the keyword set of digits start.

In the preferred embodiment, the sets of digits will be analysed by check digit algorithm, designed to check errors. This is in order that a check digit can be added to the end of the digits to perform validity checking when the number is manually entered into the telephone switch 425 by the visitor 401 using telephone keypad 423.

The sets of digits will be positively terminated by a symbol available on a telephone keypad, for example, but not limited to a (*). This enables extension numbers of indeterminate length to be used in the tracking system. When the visitor enters the number sequence by using the telephone keypad 423, this positive termination will tell the IVR 428 that the extension code has been fully entered and processing can continue.

In the preferred embodiment, the first set of digits identify the PPCall engine supplying the results, and may be of any length greater than 0. Though for reasons of practicality, it is expected the length to be under 5 digits. Web sites which are likely to result in a high volume of traffic, for example, a search engine, can be identified and entered into the data source when setting up the data source for a new client. By identifying these web sites during set up, the set of digits which relate to popular referring web sites and keywords will be kept short, E.g. 1 or 2 digits. This has benefits as the shorter a number is, the less likely it will be incorrectly entered into the telephone keypad by a visitor, and the majority of visitors to the web site will enter a short extension code.

In another embodiment of the invention, but without limitation, the first set of digits which make up the extension number may be used to represent the domain name of the web site which directed web client 401 to the merchant web site. Each domain name entered into data source 420 would be identified by a unique number. A referring domain name which does not exist in the data source 420, when searched for by API procedure 416, will be added to data source 420, and a new set of digits will be dynamically assigned by the data source 420 to that referring domain name.

The second set of digits corresponds to the keyword as extracted from URLs 203 and 205 in data packet 312 by procedures 501 or 601.

Any extracted keyword which does not exist in the data source 420 when searched for by API procedure 416 will be added to data source 420, and a new set of digits will be dynamically assigned by the data source 420 to that keyword.

Further SQL queries would be made against data source 420 by API Procedure 416 over communication link 417 in order to store the number of visits a particular web site has had, the number of views of each client telephone number, and other pertinent statistics API Procedure 416 constructs an SQL query which updates data source 420 using client website id 313, engine and keyword details as extracted from the URLs in Data Packet 312, and the current time, to log a page view for the purposes of future data mining and/or reporting.

API procedure 416 on tracking platform 414 then creates a Response Packet 314 containing the client telephone number 315 and extension number 316. API procedure 416 then outputs Response Packet 314 back to Tracking Procedure 412 through connection 413. API procedure 416 then terminates the connection 413.

Tracking Procedure 412 reads the response packet 314, extracts the telephone number 315 and extension number 316 from the Response Packet, and stores them in temporary memory and in the session 302 data.

Web Script 411, which called Tracking Procedure 412, then outputs the client telephone number 315 and extension number 316 into the appropriate place within the HTML web page 421.

When web script 411 has generated the web page 421, the web page 421 is sent through httpd process 301 to web client 201 over communication link 408. The web page with the telephone number and extension number (data code) is then displayed by the web client to the visitor 401.

At this point, therefore, the visitor 401 has performed a web search on a web search engine, using particular keywords. The search engine has then provided search results, and the user contacted one of the web sites provided as a result, using the link provided by the search engine. At the contacted web site a tracking procedure 412 is run which tracks client requests for the web site to serve its page, and in particular such requests made via a search engine. Information containing such incoming requests is passed to the tracking platform 414 in a suitable data packet, and an API procedure running on the tracking platform 414 extracts the engine and search keyword data from the request, if possible. This engine and keyword data is then passed to a data source 420 running on a data source server 419, which uses the information to generate a data code in the form, preferably, of a number, which data code is indicative of the engine and keyword data. Additionally, the data source looks up a contact telephone number to be provided in the web page to be served by the merchant web site. This contact telephone number can be used by the data source to identify the merchant, but the number itself is the number of a line connected to a switch forming part of the preferred embodiment. The data code and telephone number is then passed back to the merchant web site, which places the information into a suitable place in the web page. The web page is then served to the visitor 401. At this point, therefore, the visitor has been provided with a contact telephone number and a data code presented in the form of an extension number. However, the data code is not in reality an extension number in that it is not used to identify a telephone line or the like, but is instead a data code which can be used by the issuing data source 420 to determine the search engine and keywords which the visitor used to obtain the contact information. Moreover, the telephone number is not the actual telephone number of the merchant, but is instead the number of a line connected to a telephone switch which is used for information capture and routing, as will be described next.

Returning to FIG. 4, after receiving the web page including the telephone number and extension number visitor 401 using web client 201 is then able to ring the merchant 402 which operates the web site hosted on merchant web server 409 in the manner described next.

Within the embodiment a telephone switch 425 is provided. Telephone Switch 425 is taken as equivalent to computer environment 101. The computer would typically be situated in a data centre, with a Telephone Hardware Interface 426 consisting of multiple ISDN Adaptors, as shown in FIG. 1 as ISDN Adaptor 164. The ISDN Adaptor connects the computer to the telephone network through ISDN telephone lines, and can both receive and make telephone calls. The telephone switch computer 425 is connected to a network, allowing telephone switch 425 to communicate with Tracking Platform 414 to transfer data using connection 430. The telephone switch is connected to the PSTN via a number of telephone lines, the numbers for which are known and stored in the data source 420. One of the numbers is the telephone number provided to the visitor 401 on the web page served from the merchant web server.

When visitor 401 decides to initiate a communications session with the merchant 402 in the form of a telephone call, visitor 401 uses telephone 422, which is connected to the public telephone network. The visitor dials the telephone number given on the web page to web client 201, using Telephone Keypad 423.

The call is initially routed over connection 424 through the public telephone network through to telephone switch 425, which is connected to the public telephone network via hardware interface 426. The telephone switch reads the incoming telephone number (DDI) 307, and looks up the telephone number against local data source 429. The data source will respond with data indicating if the telephone number should be passed straight through to the merchant, or if the visitor should be put through the IVR 428 system in order for extension number to be entered.

If it is indicated in the local data source 429 that the incoming number should be given an IVR response, then the switch software 427 answers the call. If it was indicated in local data source 429 that the incoming number should be passed straight through to the merchant, thereby bypassing the above IVR response, then software 427 skips the IVR procedure. The mechanism continues as outlined below.

If the incoming call was to be put through to the IVR 428, then the local data source 429 will be checked to see if this DDI 307 number dictates a voice file should be played. If so, this voice file will welcome the visitor to the service. The voice prompt will always ask for the extension number to be entered.

Visitor 401 then uses telephone keypad 423 to enter the extension number 316 as given on the web page. The number is positively terminated as described above.

Software 427 on Telephone Switch 425 then creates a communication link 430 to API 416 on the tracking platform 414 over a network such as the internet.

The software 427 passes details of the call, such as CLI 306, DDI 307, and timestamp 309 of when the call was received to API 416. If visitor went through to the IVR 428, then the extension number 308 which was entered by visitor 401 is also sent. The data should be transferred between the systems using a valid DIM.

API procedure 416 on the Tracking platform 414 reads the inbound data, and checks the entered extension number against the check digit algorithm used in the system.

If the entered check digit is validated by the check digit algorithm, then the data will be entered into data source 420 against the appropriate engine and keyword.

If the entered check digit is not validated by the check digit algorithm, then the data will be logged, but with an error field flagging the fact the given details are incorrect.

API procedure 416 then logs the details into data source 420, preferably through a constructed SQL query, over connection 417.

In the preferred embodiment, a Record Identifier which uniquely relates to a particular entry in the data file will be returned from data source 420 to API procedure 416.

The API procedure 416 then queries data source 420 over connection 417 for the merchant telephone number 318. This is performed by using a constructed SQL query, using the DDI number 307 to look up the required data.

The data source 420 returns client telephone number 318 to API Procedure 416.

API Procedure 416 then builds up a response packet 317 containing the merchant telephone number 318, and preferably the unique Record Identifier 319.

API Procedure 416 then returns the response packet across communication link 430 and terminates the communication link.

Software 427 on telephone switch 425 reads the inbound data and extracts the merchant telephone number 318 and the unique Record Identifier 319.

The switch then places a call to the merchant 402 using the merchant telephone number 318 through the public telephone network. This creates connection 431. When the merchant answers telephone 432, the switch connects the visitor 401 to the merchant 402. The visitor 401 and merchant 402 then conduct their telephone conversation.

The telephone conversation is terminated by either visitor 401 hanging up telephone 422, or merchant 402 hanging up telephone 432.

Following this action, telephone switch 425 detects either connection 424 or connection 431 has been terminated. Software 427 then records the length of the call, and opens up a communication link 430 over a network, such as the Internet, to the tracking platform 414 through API 416, using a valid communication protocol.

In the preferred embodiment, the unique Record Identifier 319 and the call length 310 is sent to and extracted by API Procedure 416 on tracking platform 414. If the unique Record Identifier 319 is not available, then software 427 communicates the CLI 306, phone number dialled DDI 307, extension number entered 308, timestamp 309 of when the phone call was received, and call length 310 to tracking platform 414 via the API procedure 416.

API procedure 416 on tracking platform 414 updates data source 420, using SQL or another appropriate method, with the call length information for the given unique Record Identifier.

API procedure 416 then builds a response packet containing a success code to indicate the procedure has been completed. API procedure 416 then returns response packet across the communication link 430 and terminates the link. Software 427 on Telephone Switch 425 then terminates any remaining live telephone links.

With the above procedures, therefore, the preferred embodiment can collect data as to which searches led to contacts being established, and also various metrics about the actual contact communications session. This data can then be used for ROI and CPA analyses, and also for use as input to bid management software, as described previously.

To supplement the procedures described above, in a further embodiment when visitor 401 terminates the telephone call by hanging up telephone 422. Software 427 records the call length, and then uses the IVR 428 to prompt the merchant 402 over communication link 431 to enter a success code.

The merchant 401 would then enter a code, which was pre-agreed between the merchant and the tracking platform, to signal the outcome of the call using telephone keypad 433. By way of example, but not by limitation, the code (1#) could be used to indicate call not successful, code (2#) could indicate enquiry, code (3#) could indicate a sale. Furthermore, the IVR 428 could respond to the entered code by requesting the value of the sale to be entered via the telephone keypad 433, using appropriate digits to represent the amount, a (*) to indicate the decimal point, and a (#) symbol to positively terminate entry. IVR 428 would then read back to the merchant the amount to confirm the value was entered correctly. It would then request the merchant to verify the entry was correct by pressing (1) for yes, or (2) for no. The merchant would signal that the value was correct by using the telephone keypad 433. If incorrect, the merchant will repeat this IVR procedure to re-request that the merchant enter the value again.

Once the details have been successfully confirmed, Software 427 creates a communication link 430 over a network, such as the Internet, to the tracking platform 414 through API Procedure 416. The captured details are sent though communication link 430 to API Procedure 416 on tracking platform 414 with the unique Record Identifier 319.

API Procedure 416 on Tracking platform 414 receives the inbound data through the communication link 430 and extracts the unique Record Identifier 319, call length data 310 and Result of Call 311 information.

API Procedure 416 on Tracking platform 414 updates data source 420, using SQL or another appropriate method, with the call length information 310 and Result of Call information 311 for the given unique Record Identifier 319.

API Procedure 416 then builds a response packet containing a success message to indicate the procedure has been completed. API Procedure 416 then returns the success message to Software 427 on Telephone Switch 425 across the communication link 430 and terminates the link.

As another variation to provide a further embodiment, instead of a telephone calls being made over the public telephone network, using telephones 422 and 432, the visitor 401 and/or merchant 402 may instead use Voice Over IP terminals, or other to-be-developed communication methodologies. It is possible that with communication methodologies such as these, extension number (data codes) can be embedded within the communication when the call is placed, thus bypassing the requirement for the visitor to enter extension number 316. The rest of the implementation is the same as detailed above.

In another embodiment, instead of the user entering the extension number 316 into IVR 428 through telephone keypad 423, the user may speak the extension number directly into the handset of telephone 422, which would be interpreted via voice recognition software within the IVR 428. The rest of the implementation is the same as detailed above.

The above processes could also be used to generate an unlimited number of telephone numbers and extensions on a web page or a search listing to be displayed as a result of a search.

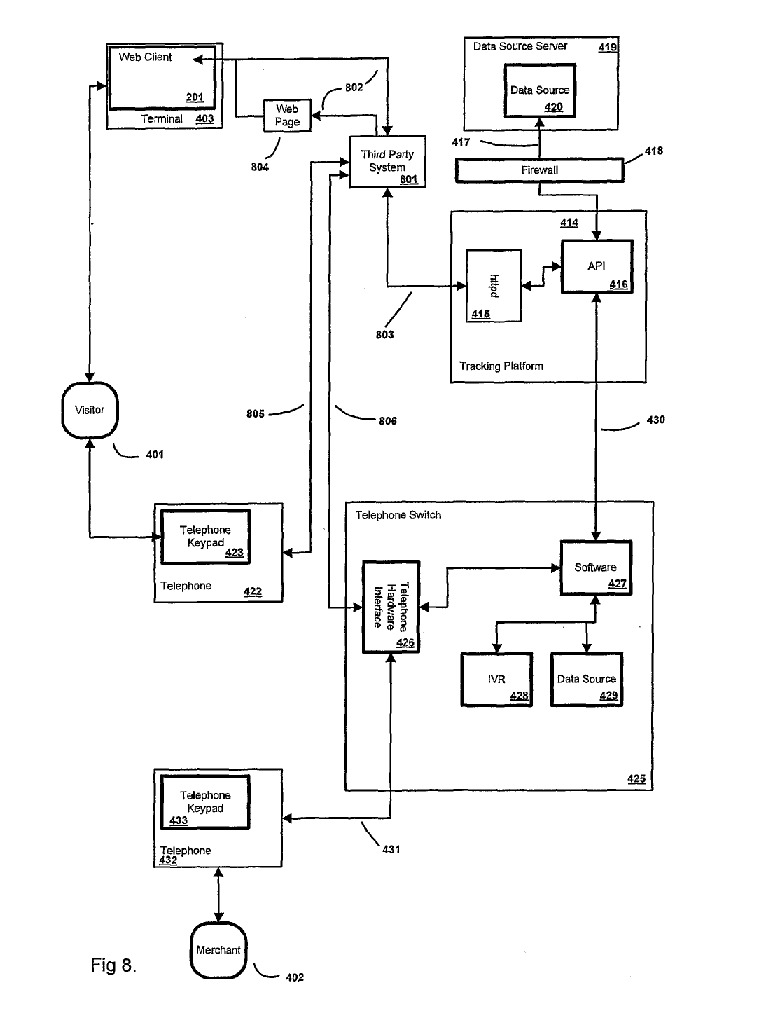

In an alternative embodiment, the processes outlined above can also be used in a PPCall environment. The telephone and extension numbers, as given by the present invention, are displayed directly on a PPCall search results page for each PPCall advertisement listed on the search results page. The implementation of this embodiment is described in FIG. 8, where the PPCall search engine would be the third party server.

More particularly, FIG. 8 describes a further embodiment of the present invention. A web client 201 may contact a Third Party System 801, over communications link 802, to perform a search. The Third Party System by example, but not limitation, may be a PPCall system. As part of the processing required to respond to the request made by web client 201, the Third Party System 801 will submit requests to the tracking platform 414 over communication link 803. API Procedure 416 operates in the same manner as described in relation to the first embodiment shown in FIG. 4. The information returned will be identical in format to data packet 314, and will contain client telephone number 315, and extension number 316. The information is then written into web page 804, which is returned to web client 201 over communication link 802.

The Third Party System may process and display the telephone and extension details in a format of their own choosing. By example, but not limitation, the Third Party System may choose to display their own telephone number, but still show the extension number as generated from the tracking platform.

When a telephone number displayed in web page 804 is dialled by Visitor 401 using telephone keypad 423 on telephone 422, the call is made over communication link 805 through the public telephone network to Third Party System 801. The call is processed by the telephone switch within Third Party System 801. The telephone switch of Third Party System 801 then dials client telephone number 315, which routes the call over communication link 806 through the public telephone network to telephone switch 425.

The rest of the implementation is the same as detailed above in respect of the first embodiment.

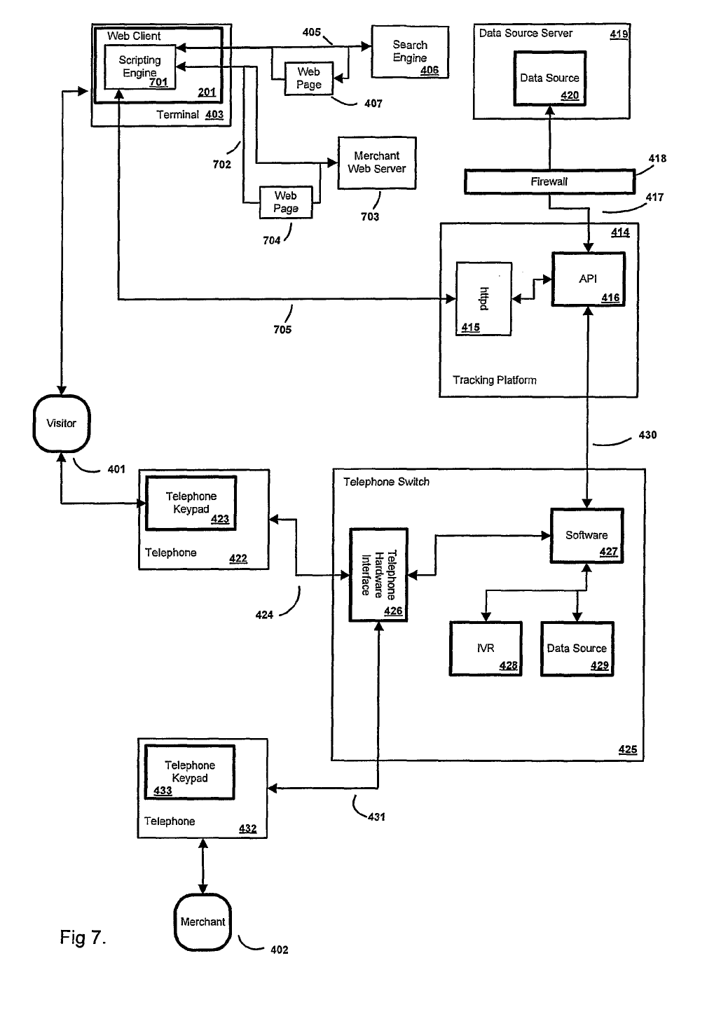

A further embodiment of the invention will now be described with respect to FIG. 7. Here, Web Client 201 is an application which runs in computer environment 403, and is controlled by visitor 401. Scripting Engine 701 runs within the web client 201.

The visitor 401, as part of their browsing process, performs a search using web client 201 at the web site of search engine 406. Web Client 201 creates a communication link 405 over a network, such as the Internet, and receives web page 407 in response to the query. Web Page 407 contains a list of search results and pay per click advertisements related to their query.

Visitor 401 clicks on a specific advertisement of interest to them, and in response web client 201 contacts the search engine 406 over communication link 405 to receive the Requested URL 205 of the merchant web site that paid for the advertisement.

The search engine web server 406 responds to web client 201 with a Response Packet, which contains the requested URL 205 of the merchant web server 703. Web client 201 then creates a connection 702 over a network, such as the Internet, to the merchant web server 703, requesting the URL 205.

The web server returns a web page 704 which contains JavaScript code as part of HTML source. The JavaScript code is executed in the scripting engine 701, which is a component of the web client 201.

The JavaScript code creates a HTTP connection 705 over a network, such as the Internet, to API Procedure 416 on tracking platform 414. Tracking Procedure API 416 operates as described in FIG. 4 above, and returns a response packet 314 to scripting engine 701. Scripting engine extracts the client telephone number 315 and extension 316 information from the response packet 314, and dynamically displays this information in the appropriate place within the HTML web page, which is shown to the visitor 401.

The rest of the implementation is then the same as described in relation to the first embodiment shown in FIG. 4.

As a result of the implementation and operation of any of the above-described embodiments, information can be gathered as to which search terms and/or which search engines led to contact being established. This information can then be used in a pay-per-call method in a conventional manner, and further allows that reports can be constructed as frequently as required using the data held in data source 420, enabling a merchant to better understand visitor activity which has occurred from search. By example, but not limitation, such reports may show the number of visitors who found the web site on a particular search engine by using a particular keyword; compare the average call lengths of people who visited the site with the keywords which resulted in their visit; compare the number of people who visited the site from a certain keyword to those who called the merchant using the specific extension code for that keyword, and so analyse the effectiveness of that online advertising. The data held in data source 420 may also be used to optimise advertising campaigns through management software, by example, but not limited to, BidBuddy®. None of these functions would be possible without the data collection performed by the embodiments of the invention.

1. A method of tracking search information, comprising the steps of:
receiving data indicative of at least a search term used by a user to perform a search of an information source;
generating a token having a property indicative of the search term;
providing the token for communication to the user;
receiving data indicative that the user has undertaken a communications session with a third party and communicated the token to the third party; and
storing information relating to said token communication in a data store.

2. The method according to claim 1, and further comprising receiving data indicative of a search tool which performed the search of the information source using the search term, the token being generated so as to be indicative of the search term and the search tool.

3. The method according to claim 1, wherein the information source is the World Wide Web, and wherein the search of the information source using the search term is performed by a web search engine.

4. (canceled)

5. The method according to claim 1, wherein the search term comprises one or more keywords.

6. The method according to claim 1, wherein the communications session is a telephone call or a VOIP session.

7. (canceled)

8. The method according to claim 6, wherein the storing step further comprises storing information relating to said communications session, and wherein the information relating to said communications session comprises one or more types of data selected from the group consisting of: CLI data, DDI data, time of call, and duration of call.

9. The method according to claim 1, and further comprising receiving and storing information relating to an outcome of the communications session.

10. The method according to claim 1, wherein the token is a sequence of one or more alphanumeric characters.

11. The method according to claim 1, further comprising providing contact data to enable the user to contact the third party for communication to the user.

12. The method according to claim 11, wherein the token is provided in the same format as the contact data.

13. The method according to claim 11, wherein the contact data is contact data for a routing means, and wherein the routing means routes the communications session from the user to the third party.

14. The method according to claim 11, wherein the contact data is a telephone number.

15. The method according to claim 1, wherein the token is generated by looking up a value therefor in a look-up table, and wherein the look-up table that indexes token values against at least search terms.

16. The method according to claim 15, further comprising:
determining whether at least the search term is contained in the look-up table;
dynamically generating a new token based on the determination; and
entering the new token into the look-up table in association with the search term.

17. The method according to claim 15, wherein the look-up table indexes tokens against search terms and search tool names.

18-43. (canceled)

44. A method for use in tracking search information, comprising the steps of:
receiving an incoming request from a user for establishment of a communications session with a third party;
receiving information indicative of a property of a token from the user, said property being indicative of a search term used in a search of an information source previously conducted by the user;
providing said information for storage; and
establishing said communications session between said user and said third party.

45-54. (canceled)

55. The method according to claim 44, wherein the step of receiving information indicative of the property of the token from the user further comprises prompting said user to communicate said property; and monitoring said user response.

56. The method according to claim 55, wherein said prompt and response are issued and monitored using an interactive voice response system.

57. A method for use in tracking search information comprising the steps of:
receiving a search request from a user, the search request comprising one or more search terms;
performing a search of an information source to determine one or more pertinent search results, each of the one or more pertinent search result results being associated with a third party;
sending a query message to a data source, the query message including data indicative of at least one of the one or more search terms;
receiving, in response to the query message, at least one token having a property indicative of the at least one of the one or more search terms; and
providing to the user the search results together with the token.

58-64. (canceled)

65. A method of tracking search terms used as keywords for searches of the Internet using a search engine, comprising:
receiving a URL containing keyword and search engine data relating to a search performed by a user;
parsing the URL to determine keywords and a name of a search engine on which the search was performed;
generating a data sequence based on the determined keywords and search engine name, and storing an association between the data sequence and the determined keywords and search engine name;
providing the data sequence for communication to the user; and then subsequently:
monitoring communications made by the user with a third party to determine if said user communicates said data sequence; and
storing information relating to the communication of said data sequence to determine which search terms led to establishment of communications between the user and the third party.

66-67. (canceled)

68. A system for tracking search information, comprising:
a communications interface arranged in use to:
i) receive data indicative of at least a search term used by a user to perform a search of an information source;
ii) provide a token for communication to the user; and
iii) receive data indicative that the user has undertaken a communications session with a third party and communicated the token to the third party;
a data generator arranged in use to generate the token, the token having a property indicative of the search term; and
a data store arranged to store information relating to said token communication.

69-110. (canceled)

111. A system for use in tracking search information, comprising:
communications means arranged in use to:
i) receive an incoming request from a user for establishment of a communications session with a third party;
ii) receive information indicative of a property of a token from the user, said property being indicative of a search term used in a search of an information source previously conducted by the user; and
iii) provide said information for storage; and
a controller arranged in use to establish said communications session between said user and said third party.

112-123. (canceled)

124. A system for tracking search terms used as keywords for searches of the Internet using a search engine, comprising:
a communications interface for receiving a URL containing keyword and search engine data relating to a search performed by a user;
a processor for:
parsing the URL to determine keywords and a name of a search engine on which the search was performed; and
generating a data sequence based on the determined keywords and search engine name, and storing an association between the data sequence and the determined keywords and search engine name;
the communications interface being further arranged to provide the data sequence for communication to a user; the system further comprising for subsequent operation:
a communications session monitor for monitoring communications made by the user with a third party to determine if said user communicates said data sequence; and
a data store for storing information relating to the communication of said data sequence;
whereby the system determines which search terms led to establishment of communications between the user and the third party.

125. A system for use in tracking search information comprising:
a communications means arranged in use to:
receive a search request from a user, the search request comprising one or more search terms;
a search engine for performing a search of an information source to determine one or more pertinent search results, each of the one or more pertinent search results being associated with a third party;
the communications means being further arranged in use to:
send a query message to a data source, the query message including data indicative of at least one of the one or more search terms;
receive, in response to the query message, at least one token having a property indicative of the at least one of the one or more search terms; and
provide to the user the search results together with the token.

126-132. (canceled)

133. The method according to claim 1, further comprising receiving and storing information relating to content of the communications session.

134. The method according to claim 1, further comprising receiving and storing information relating to an outcome and content of the communications session.
